(19) United States
(12) Patent Application Publication
(10) Pub. No.: US 2009/0250504 A1
(43) Pub. Date: Oct. 8, 2009

(54) Solder applying apparatus

(75) Inventors: Ching-Sheng Chang, Taichung Hsien (TW); Jin-Chin Guo, Tainan Hsien (TW); Hsin-Shun Chen, Changhua Hsien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Universal Scientific Industrial Co., Ltd., Nan-Tou Hsien (TW)

(21) Appl. No.: 12/080,622

(22) Filed: Apr. 2, 2008

(51) Int. Cl. B23K 37/00

(52) U.S. Cl. 228/36; 228/33

(57) ABSTRACT

A solder applying apparatus includes a tray body having a base portion and a surrounding portion extending from a periphery of the base portion, cooperating with the base portion to define a solder-accommodating space therebetween for receiving a solder material therein, and having a top end distal from the base portion. The base portion has an inner wall confining a bottom side of the solder-accommodating space. The inner wall of the base portion is divided into a plurality of parallel planar regions. Each of the planar regions cooperates with an adjacent one of the planar regions to define a step therebetween so as to permit the planar regions to have different depths relative to the top end of the surrounding portion.

### BACKGROUND OF THE INVENTION

1. Field of the Invention

This invention relates to a solder applying apparatus, more particularly to a solder applying apparatus including a tray body with a base portion that has an inner wall divided into a plurality of parallel planar regions.

2. Description of the Related Art

FIG. 1 illustrates a package on package (PoP) type electronic assembly 10 formed by assembling Ball Grid Array (BGA) type first and second electronic packages 11, 12 and a circuit board 13 together. During assembly of the first and second electronic packages 11, 12 and the circuit board 13, solder balls 17 of the second electronic package 12 are applied with a solder material 16 (see FIG. 2) in a conventional solder tray 3 prior to attachment to bonding pads 15 of the first electronic package 11. In a similar manner, solder balls 14 of the first electronic package 11 are applied with the solder material 16 prior to attachment to bonding pads 131 of the circuit board 13. The solder material 16 applied to the electronic assembly 10 is subsequently subjected to a reflow process so as to bond the first and second electronic packages 11, 12 and the circuit board 13 together. In order to achieve a better bonding between the bonding pads 15 of the first electronic package 11 and the solder balls 17 of the second electronic package 12 during reflowing of the solder material 16, application of the solder material 16 to the solder balls 17 requires about half of each of the solder balls 17 to be submerged into the solder material 16 in the solder tray 3. As illustrated in FIG. 2, the solder material 16 in the conventional solder tray 3 has a depth (h) that is uniform throughout the entire solder tray 3, and that is about half diameter (d) of each of the solder balls 17 of the second electronic package 12 so as to permit half of each of the solder balls 17 to be submerged into the solder material 16 in the conventional solder tray 3. However, since the depth (h) of the solder material 16 in the conventional solder tray 3 is uniform throughout the entire solder tray 3, when a third electronic package 12′, which has solder balls 17′ with a diameter (d′) smaller than the diameter (d) of the solder balls 17, is to be simultaneously applied with the solder material 16 with the second electronic package 12, the amount of the solder material 16 applied to each of the solder balls 17′ of the third electronic package 12′ will be insufficient, which results in poor bonding between the solder balls 17′ of the third electronic package 12′ and bonding pads of another electronic package (not shown).

### SUMMARY OF THE INVENTION

Therefore, an object of the present invention is to provide a solder applying apparatus that can overcome the aforesaid drawback associated with the prior art.

According to this invention, there is provided a solder applying apparatus for applying a solder material to electronic packages of an electronic assembly. The solder applying apparatus comprises a tray body including a base portion and a surrounding portion extending from a periphery of the base portion, cooperating with the base portion to define a solder-accommodating space therebetween for receiving the solder material therein, and having a top end distal from the base portion. The base portion has an inner wall confining a bottom side of the solder-accommodating space. The inner wall of the base portion is divided into a plurality of parallel planar regions. Each of the planar regions cooperates with an adjacent one of the planar regions to define a step therebetween so as to permit the planar regions to have different depths relative to the top end of the surrounding portion.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic view of a package on package (PoP) type electronic assembly;

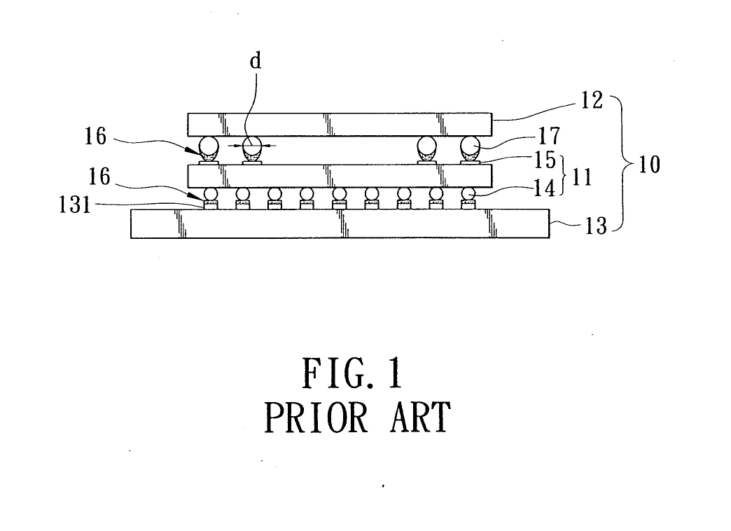

FIG. 2 is a schematic partly sectional view of a conventional solder applying apparatus for applying a solder material to electronic packages of the electronic assembly of FIG. 1;

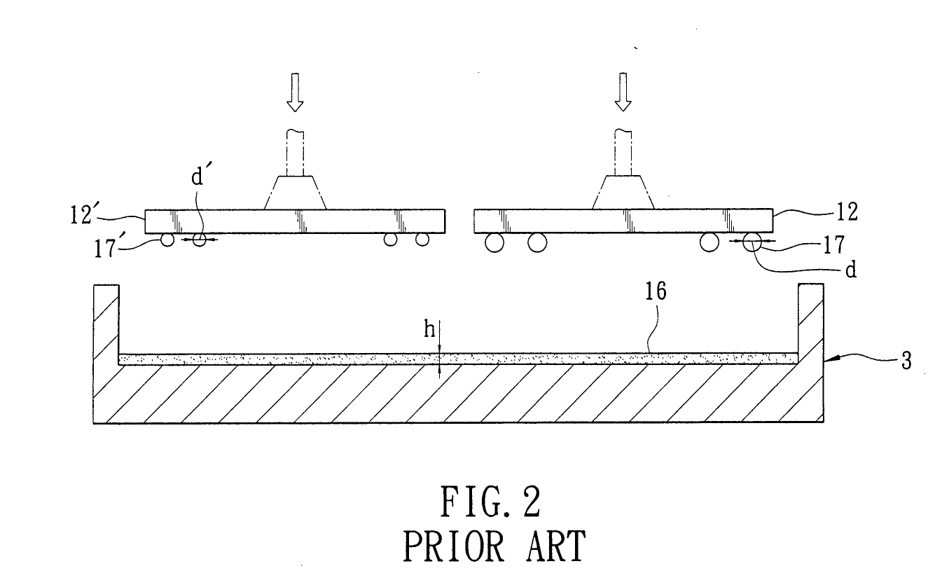

FIG. 3 is a schematic partly sectional view of the first preferred embodiment of a solder applying apparatus according to this invention;

FIG. 4 is a schematic view of an electronic assembly with a solder material applied by the solder applying apparatus of this invention; and

FIG. 5 is a schematic partly sectional view of the second preferred embodiment of the solder applying apparatus according to this invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

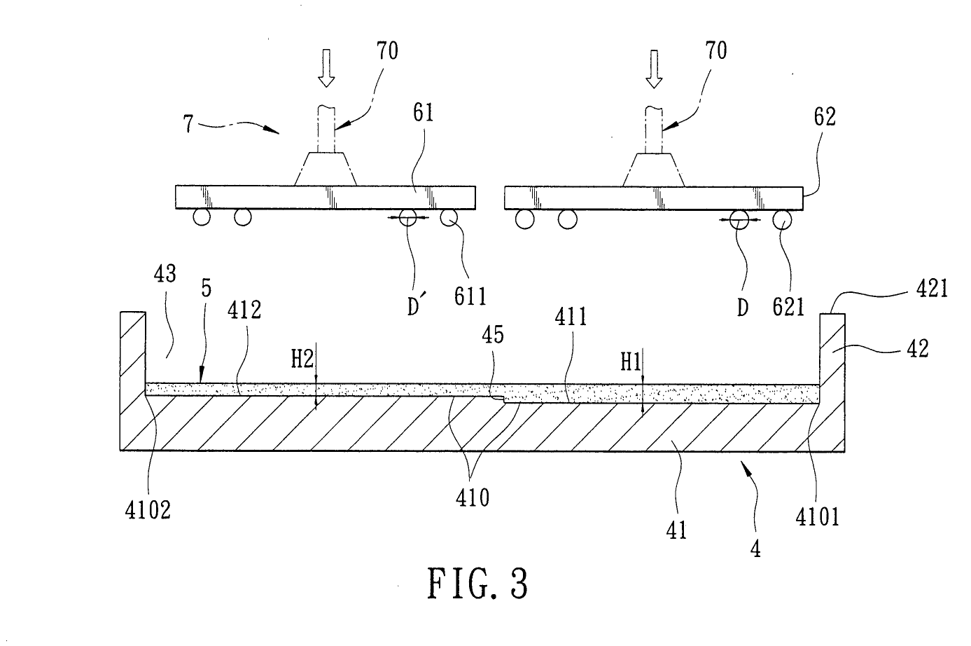

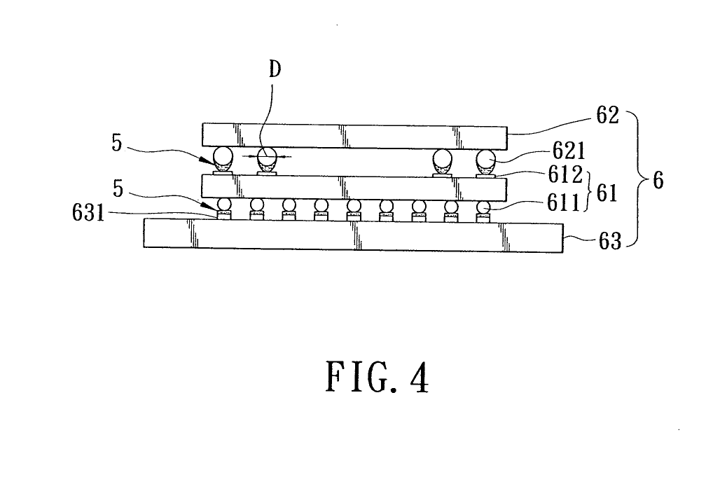

FIG. 3 illustrates the first preferred embodiment of a solder applying apparatus for applying a solder material 5 to first and second electronic packages 61, 62 of an electronic assembly 6 (see FIG. 4) according to the present invention. The solder applying apparatus includes a tray body 4 and a suction device 7. The tray body 4 includes a base portion 41 and a surrounding portion 42 extending from a periphery of the base portion 41, cooperating with the base portion 41 to define a solder-accommodating space 43 therebetween for receiving the solder material 5 therein, and having a top end 421 distal from the base portion 41. The base portion 41 has an inner wall 410 confining a bottom side of the solder-accommodating space 43. The inner wall 410 of the base portion 41 is divided into a plurality of parallel planar regions. Each of the planar regions cooperates with an adjacent one of the planar regions to define a step 45 therebetween so as to permit the planar regions to have different depths (H1, H2) relative to the top end 421 of the surrounding portion 42. In this embodiment, the planar regions include first and second planar regions 411, 412 that extend respectively from opposite ends 4101, 4102 of the inner wall 410 to the step 45 formed between the first and second planar regions 411, 412.

The suction device 7 includes two suction heads 70, each of which is adapted to hold a respective one of the first and second electronic packages 61, 62 and each of which is movable so as to align the respective one of the first and second electronic packages 61, 62 with a respective one of the first and second planar regions 411, 412 and to submerge solder balls 611, 621 of the respective one of the first and second electronic packages 61, 62 into the solder material 5 received in the solder-accommodating space 43 in the tray body 4. The depth (H1) of the first planar region 411 is about one half of the diameter (D) of the solder balls 621 of the second electronic package 62, and the depth (H2) of the second planar region 412 is about one half of the diameter (D′) of the solder balls 611 of the first electronic package 61.

After application of the solder material 5 to the solder balls 611, 621 of the first and second electronic packages 61, 62, the solder balls 611, 621 of the first and second electronic packages 61, 62 can be bonded to bonding pads 631 of a circuit board 63 and bonding pads 612 of the first electronic package 61 through the solder material 5, respectively, as best illustrated in FIG. 4. The applied solder material 5 is subsequently subjected to a reflow process.

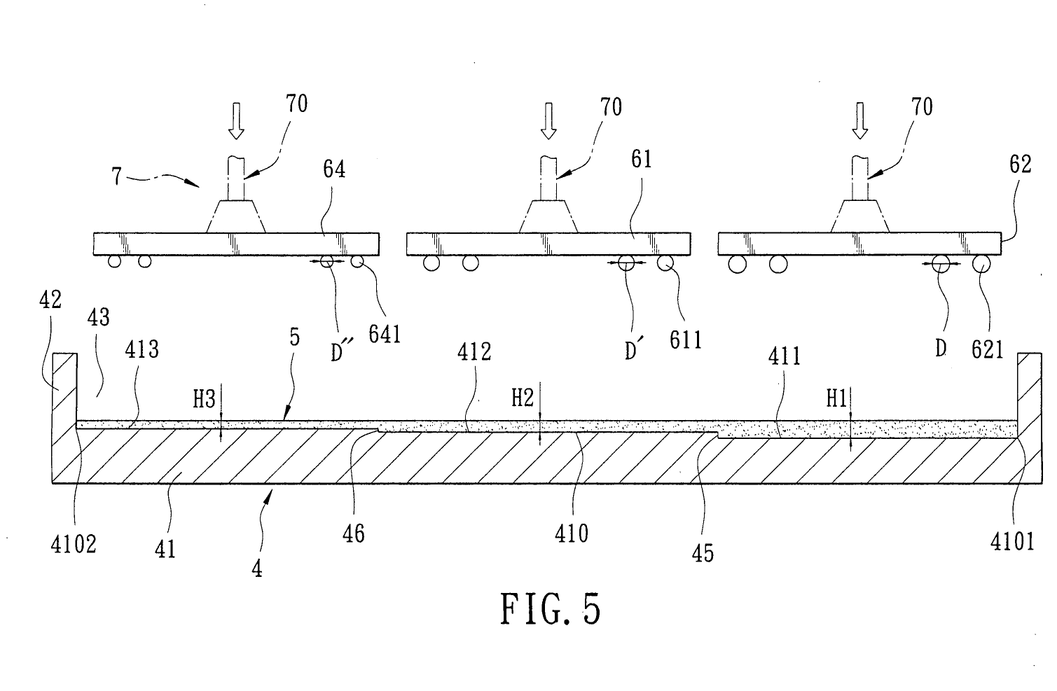

FIG. 5 illustrates the second preferred embodiment of the solder applying apparatus according to this invention. The second preferred embodiment differs from the previous embodiment in that the planar regions of the inner wall 410 of the base portion 41 include first, second and third planar regions 411, 412, 413 for applying the solder material 5 to the first and second electronic packages 61, 62 and a third electronic package 64. The second planar region 412 extends between the first and third planar regions 411, 413. The first and third planar regions 411, 413 extend from the opposite ends 4101, 4102 of the inner wall 410 to the step 45 formed between the first and second planar regions 411, 412 and the step 46 formed between the second and third planar regions 412, 413, respectively. The second step 46 has a level higher than that of the first step 45.

In this embodiment, the depth (H1) of the first planar region 411 is about one half of the diameter (D) of the solder balls 621 of the second electronic package 62, the depth (H2) of the second planar region 412 is about one half of the diameter (D′) of the solder balls 611 of the first electronic package 61, and the depth (H3) of the third planar region 413 is about one half of a diameter (D″) of the solder balls 641 of the third electronic package 64.

By configuring the planar regions of the inner wall 410 of the base portion 41 of the tray body 4 of the solder applying apparatus of this invention with different depths corresponding to the solder balls 611, 621 of the first and second electronic packages 61, 62, the aforesaid drawback associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A solder applying apparatus for applying a solder material to electronic packages of an electronic assembly, said solder applying apparatus comprising:
a tray body including a base portion and a surrounding portion extending from a periphery of said base portion, cooperating with said base portion to define a solder-accommodating space therebetween for receiving the solder material therein, and having a top end distal from said base portion, said base portion having an inner wall confining a bottom side of said solder-accommodating space;
wherein said inner wall of said base portion is divided into a plurality of parallel planar regions, each of said planar regions cooperating with an adjacent one of said planar regions to define a step therebetween so as to permit said planar regions to have different depths relative to said top end of said surrounding portion.

2. The solder applying apparatus of claim 1, wherein said inner wall of said base portion has two opposite ends, said planar regions including first and second planar regions that extend respectively from said opposite ends of said inner wall to said step formed between said first and second planar regions.

3. The solder applying apparatus of claim 1, wherein said inner wall of said base portion has two opposite ends, said planar regions including first, second and third planar regions, said second planar region extending between said first and third planar regions, said first and third planar regions extending from said opposite ends of said inner wall to said step formed between said first and second planar regions and said step formed between said second and third planar regions, respectively.

4. The solder applying apparatus of claim 1, further comprising a suction device that includes a plurality of suction heads, each of which is adapted to hold a respective one of the electronic packages and each of which is movable so as to align the respective one of the electronic packages with a respective one of said planar regions and to submerge solder balls of the respective one of the electronic packages into the solder material received in said solder-accommodating space in said tray body.
